(19) United States
(12) Patent Application Publication
(10) Pub. No.: US 2025/0118155 A1
(43) Pub. Date: Apr. 10, 2025

(54) GAMING MACHINE TESTING SYSTEM WITH DYNAMIC VIRTUAL STREAMING

(71) Applicant: LNW Gaming, Inc., Las Vegas, NV (US)

(72) Inventors: Victor BLANCO, Las Vegas, NV (US); Mili DALMIA, Bangalore (IN); Donovan MEYER, Austin, TX (US)

(21) Appl. No.: 18/907,850

(22) Filed: Oct. 7, 2024

Related U.S. Application Data
(60) Provisional application No. 63/588,812, filed on Oct. 9, 2023.

(51) Int. Cl. G07F 17/32

(52) U.S. Cl. CPC G07F 17/3227; G07F 17/3211; G07F 17/323; G07F 17/3239

(57) ABSTRACT

A system and method(s) for testing a land-based gaming machine is described. For instance, a system generates a video stream showing a first view of a land-based gaming machine physically located within a secure gaming test environment. The system further transmits, via a communications network, the video stream to a user computing device that is external to the secure gaming test environment. The system further animates play of an in-development wagering game presented via the first view. The system further detects a change in state, related to presentation of the in-development wagering game, of the gaming machine or the user computing device. The system further determines, based on the change in state, a second view of the land-based gaming machine to present via the user computing device. The second view is different from the first view. The system further automatically modifies the video stream to present the second view.

### CROSS-REFERENCE TO RELATED APPLICATION(S)

This patent application claims priority benefit of U.S. Provisional Patent Application No. 63/588,812 filed Oct. 9, 2023, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD

The present invention relates generally to apparatus and methods for presenting and evaluating gaming content.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines as well as those machines, or systems, that are easy to use.

Typically, a game developer will go through a long development cycle (e.g., 12-18 months) to generate a wagering game that is complete and meets all regulatory requirements. Afterwards, the game is released for casino play. However, if at that point the game is unacceptable or unpopular to casino patrons, the game may need to be removed or replaced, and the development time and expense spent having developed the game represents a loss for the game developer.

Therefore, there is a need for game developers (e.g., wagering game machine manufacturers) to test in-development gaming features of a land-based gaming machine to determine popularity of the gaming features and/or to improve the gaming features prior to submitting the in-development wagering game and/or gaming machine to an expensive and time-consuming regulatory approval process.

### SUMMARY

According to an embodiment of the present disclosure, a system to generate, via one or more image capture devices, a video stream showing a first view of a land-based gaming machine physically located within a secure gaming test environment. The system can further transmit, via a communications network, the video stream to a user computing device external to the secure gaming test environment. The video stream is for presentation via a screen of the user computing device. The system can further conduct, in response to a user input received from the user computing device after transmitting the video stream, play of an in-development wagering game presented via the first view. The system can further detect a change in state of one or more of the gaming machine or the user computing device. The change of state is related to presentation of the in-development wagering game. The system can further determine, based on the change in state, a second view of the land-based gaming machine to present via the user computing device. The second view is different from the first view. The system can further automatically modify the video stream to present the second view.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example gaming network according to one or more embodiments of the present disclosure.

FIG. 2 is a diagram of an example dynamic, image-capture array according to one or more embodiments of the present disclosure.

FIG. 3 illustrates an example of a method flow of land-based gaming machine testing via dynamic streaming according to one or more embodiments of the present disclosure.

FIGS. 4A and 4B are illustrations of dynamic streaming based on a first game state according to one or more embodiments of the present disclosure.

FIGS. 5A, 5B, and 5C are illustrations of dynamic streaming based on a second game state according to one or more embodiments of the present disclosure.

FIGS. 6A, 6B, and 6C are illustrations of dynamic streaming based on a third game state according to one or more embodiments of the present disclosure.

FIG. 7 is a perspective view of a free-standing gaming machine according to one or more embodiments of the present disclosure.

FIG. 8 is a gaming-machine architecture according to one or more embodiments of the present disclosure.

FIG. 9 is a diagram of a computer system according to one or more embodiments of the present disclosure.

FIG. 10 illustrates an example of dynamic streaming for a community game feature according to one or more embodiments of the present disclosure.

FIG. 11A-11E illustrate an example of dynamic streaming based on a change of orientation of a user computing device according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

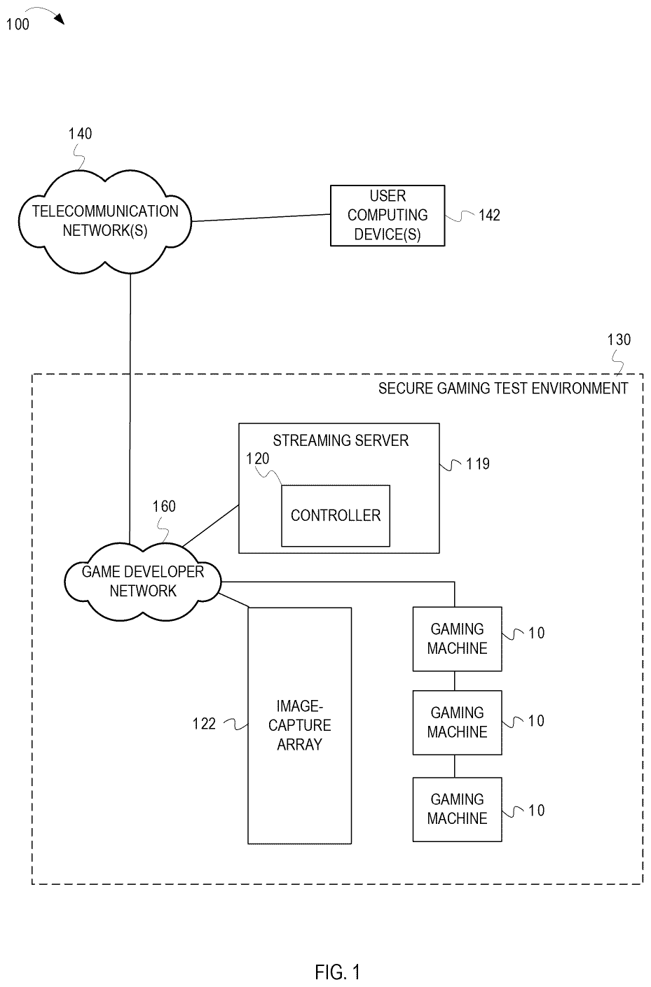

FIG. 1 is a diagram of an example gaming network (“network 100”) according to one or more embodiments of the present disclosure. The network 100 includes at least one user computing device 142, and a secure gaming test environment 130 (including a streaming server 119, an image capture array 122, and one or more gaming machines (e.g., one or more of gaming machine 10)) communicatively coupled (e.g., connected within the network 100) to each other via one or more telecommunication networks (i.e., “telecommunication network(s) 140”) and/or via one or more private networks (e.g., a game developer network 160). In some embodiments, the telecommunication network(s) 140 include, but are not limited to, the Internet, a computer network, a cell phone communication network, etc. In one embodiment, the secure gaming test environment 130 includes a gateway or proxy (not shown) communicatively coupled via the game developer network 160 to the streaming server 119.

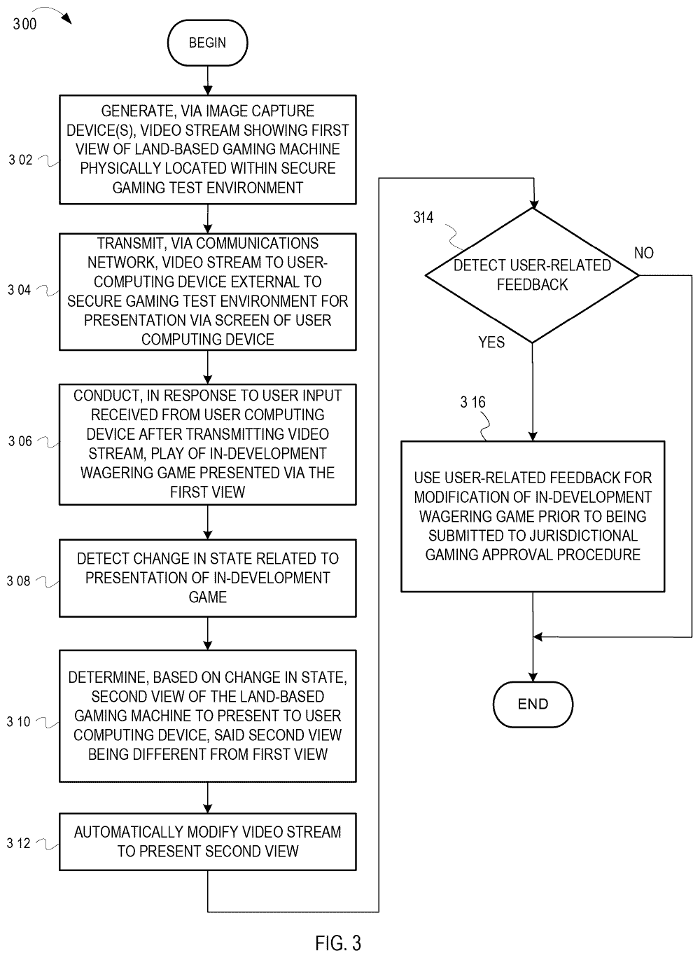

In one embodiment, the streaming server 119 streams video and audio. An electronic controller of the streaming server 119 (e.g., controller 120), controls all aspects of the secure gaming test environment 130 including, but not limited to: (i) capturing, based on game state, video of various views of areas of gaming machine(s) 10 (via the image capture array 122); (b) streaming the various views of the gaming machine 10 (e.g., see flow 300 of FIG. 3); (c) tracking user inputs accepted or entered via the user computing device 142; (d) managing a lobby system for determining which gaming machines are available (not being played at the moment) and assigning a gaming machine (e.g., a gaming machine ID) to a player account (e.g., to a player account ID) that enters the system; (e) managing streaming of views of game features for individual play and group play; (f) managing testing credits (e.g., manages the amount of credits provided based on the game play feature to be tested or amount of features to be tested and tracks the amount of credits left (not yet used) in each session compared to the amount required to trigger or present the game features); (g) managing user feedback (e.g., manages specific gaming machines to be played by the user and/or features to present to the user, provides incentives for completing surveys related to presented machines/game features, etc.), and so forth. The controller 120 incorporates a multimedia stream with a gaming channel application installed on the user computing device 142. In one embodiment, the gaming channel application is associated exclusively with the streaming server 119. In another embodiment, the gaming channel application is optionally associated with an online gaming channel system (not shown) which provides online gaming content (e.g., SciPlay.com) including a feature that provides a player access to (e.g., invites a player to play) an in-development wagering game in order to test or review the game (e.g., to present in-development game features via various streamed views, to detect player-related feedback, to improve the in-development wagering game before submitting to a regulatory approval process, etc.).

The user computing device 142 can be associated with a user account or profile for the gaming channel application, which the user computing device 142 can log into. In one embodiment, the controller 120 communicates with the gaming channel application (and vice versa) via one or more application programming interfaces (API's) of the in-development wagering game, the gaming machine 10, the user computing device 142, an online gaming channel system, etc. The gaming channel application presents, via a screen of the user computing device 142, the various streamed views (transmitted from the streaming server 119) of the various portions or areas of the gaming machine 10 that correspond to a given game state.

The controller 120 is also configured to detect user feedback (e.g., player-related feedback, spectator-related feedback, etc.), either directly or indirectly. The controller 120 can use the feedback (and or conveys the user feedback to the game developer) to modify one or more characteristics of the in-development wagering game to improve the game and/or the gaming machine 10 before submitting the game and/or gaming machine 10 to a regulatory (e.g., jurisdictional) approval process.

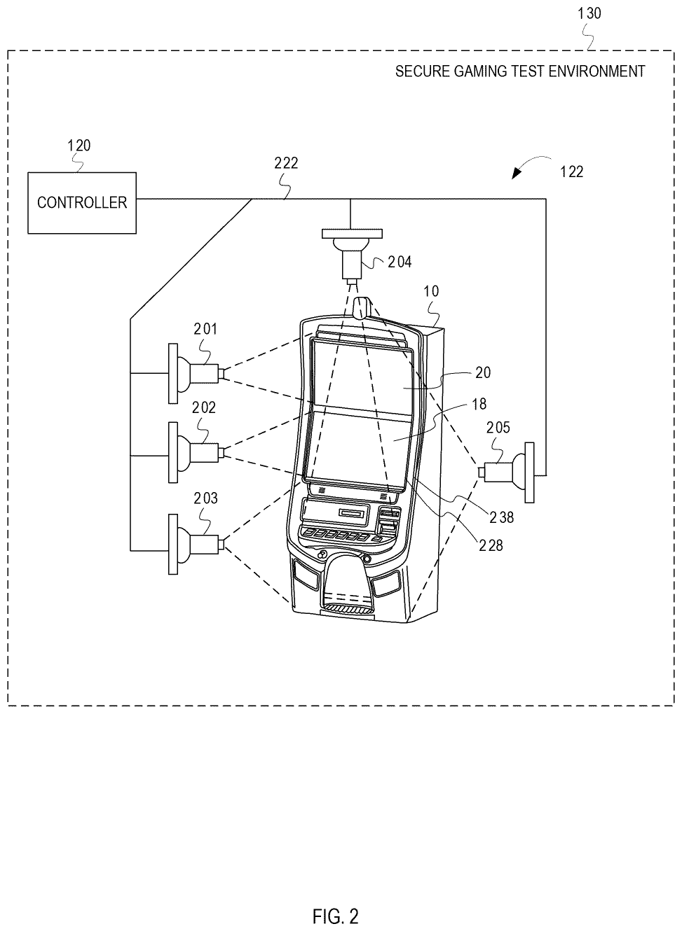

FIG. 2 is a diagram of an example dynamic, image-capture array according to one or more embodiments of the present disclosure. In one embodiment, as shown in FIG. 2, the image capture array 122 includes a plurality of cameras 201, 202, 203, 204, and 205 (collectively referred to as cameras 201-205). The cameras 201-205 are positioned within the secure gaming test environment 130 relative to (e.g., in front of, behind, to the sides of, etc.) the gaming machine 10. The secure gaming test environment includes lighting equipment that directs a proper degree of lighting at the gaming machine 10 for recording and broadcasting. The controller 120 has control of the lighting equipment to modify lighting levels, to select a type of lighting for a certain area, etc. The cameras 201-205 are fixed on (e.g., oriented toward, focused on, etc.) areas of the gaming machine 10 that are related to presentation of the game. For example, the areas are configured to present some visual aspect of the in-development wagering game, such as, but not limited to, game content, emotive lighting, button panels, game meters (e.g., credit meters, bet meters, win meters, etc.), presentation devices (e.g., displays), etc. The cameras 201-205 are high resolution cameras (e.g., 8K resolution cameras), to capture, within a video feed, a high-resolution stream of the game play (e.g., game animations, game controls, emotive lighting effects, etc.) as the game appears on various portions of the gaming machine 10 (e.g., as presented via a primary display, via a secondary display, via a button panel, etc.). In one embodiment, the cameras 201-205 are positioned to view certain areas. For instance, camera 201 is positioned to primarily view the secondary presentation device 20, camera 202 is positioned to primarily view the primary presentation device 20, camera 203 is positioned to primarily view the lower portion of the gaming machine 10, camera 204 is positioned to primarily view a button panel, and camera 205 is positioned to view the full height and width of the gaming machine 10. The controller 120 can switch the cameras 201-205 on and off as needed.

In one embodiment, the cameras 201-205 are motorized (e.g., have one or more motorized elements and/or are supported by one or more motorized elements). The one or more motorized elements include, but are not limited to, one or more of a zoom lens, a camera rig device, a mount, a slider, a pan head, a tilt head, a tripod head (e.g., to control pan, tilt, yaw, etc. for the tripod), an overhead camera mount, a boom lift, a crane, a crane jib, a pole jib, a gimbal, a steadicam, a glidecam, a pedestal rig, a camera dolly, a slider rig, a camera stabilizer, a Snorricam rig, a drone, etc. Thus, the controller 120 can move one or more aspects of the cameras 201-205 in some way, such as to pan, focus, zoom, etc. onto different parts of the gaming machine 10 that show different portions of the in-development wagering game. In another example, for a community game feature, one of the cameras 201-205 (e.g., camera 205) can zoom out on a bank of gaming machines 10 to display at least some portion of the bank, to display an entire bank of games being played, etc. The cameras 201-205 are connected via a local network 222 (e.g., a wired network) that transmits electronic communications between the controller 120 and the cameras 201-205 (including to/from any microprocessors, controllers, etc. associated with motorized elements of the camera or any motorized support elements for a camera). The cameras 201-205, thus can move to and/or focus in on any portion of the gaming machine 10 required to demonstrate and test the presentable content associated with in-development wagering game.

It should be noted that while the example of the image-capture array 122 shows a plurality of cameras (or other such image-capture devices and/or image sensors), in one embodiment, the image-capture array 122 includes a different number of cameras (e.g., fewer cameras, such as a single camera). For example, one embodiment includes three static cameras, such as a cabinet view (e.g., a view of an entire cabinet of the gaming machine), main feature view (e.g., a view of the primary game on the gaming machine) a secondary feature view (e.g., a view of a secondary feature of the gaming machine or a view of a secondary feature with the view of the primary/base game), Each of the three static cameras may remain in a fixed position (each facing different views), however may still change some physical characteristics or physical state, such as a change in an orientation (e.g., via pan, tilt, pitch, yaw, roll, etc.), focus, zoom, etc. in that fixed position. The controller 120 can switch between the three views as needed (e.g., based on game state, game-related events, user computing device orientation, test environment constraints, etc). In one embodiment, the image-capture array 122 consists of a single camera, which the controller 120 can control to dynamically change position, orientation, focus, etc. (e.g., to move, slide, zoom, pan, tilt, etc.), such as to view details (e.g., subsections) on the areas of the gaming machine 10 that present the gaming content for the in-development wagering game. For instance, the controller 120 can use one camera to show a first view of the entire gaming machine 10. Thereafter, based on a change of state (e.g., of the gaming machine 10 or the user computing device 142), which change of state is related to a presentation of the game (e.g., a change of the game state that affects content presentation, a change of gaming channel application state representative of user input and/or game events, a change of physical state (e.g., orientation, position, acceleration, etc.) of the user computing device, etc.), the controller 120 can use the single camera to move dynamically to a required location, to zoom in on an area associated with the detected game state, perform other operations described herein as related to use of the testing-environment cameras, etc. In some examples, an embodiment the uses multiple cameras can prevent issues involved with possible drift of a single camera from a set location (e.g., based on repeated and/or rapid movements). In other embodiments, a single camera may be positioned in front of the camera at a central location far enough from the gaming machine to include a full view of the gaming machine. The single camera can also be static (e.g., does not move away from a set position), yet can change orientation, focus, zoom, etc. to focus on various areas of the gaming machine. In one example (e.g., such as when using digital zooming), the single camera takes images at a high resolution (e.g., 8K) so any digital zooming that occurs, which causes a reduction in resolution due the digital zoom, still has sufficient resolution to meet a minimum resolution requirement for any given view (e.g., 4K or 1080P).

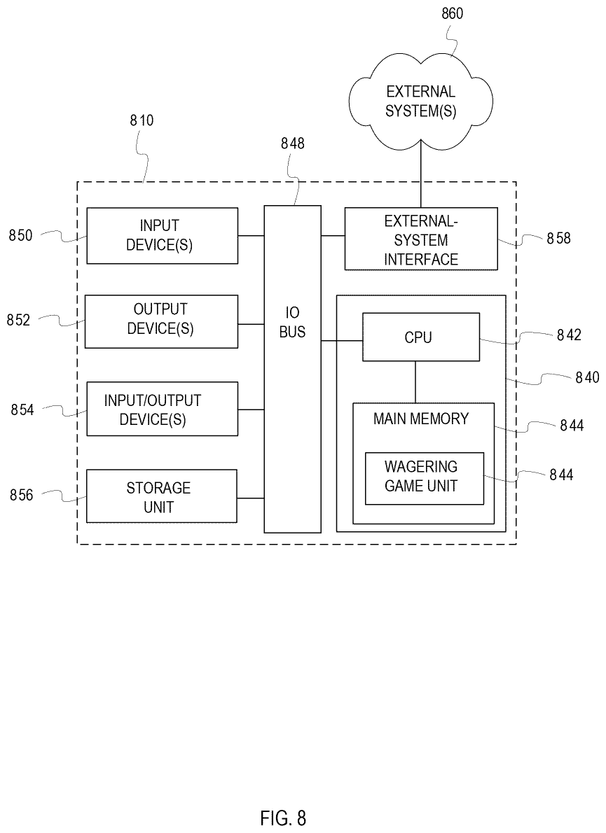

FIG. 3 illustrates an example of a method flow (“flow 300”) according to one or more embodiments of the present disclosure. The description of FIG. 3 refers to a “processor” that performs operations associated with the flow 300. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, one or more devices of the network 100, such as any one of the devices connected via the game developer network 160 or any device connected via the telecommunications network(s) 140. In one embodiment, the processor may be the central processing unit (CPU) 842 (see FIG. 8) or a processor in another device mentioned herein, such as a processor associated with the computer 900, a table controller, a card-handling device, a camera controller, a game controller, a gaming server etc. Furthermore, FIGS. 1, 2, 4A, 4B, 5A, 5B, 5C, 6A, 6B, and 6C will be referenced in the description of FIG. 3.

In FIG. 3, the flow 300 begins at processing block 302, where a processor generates, via image capture device(s), a video stream showing a first view of a land-based gaming machine physically located within a secure gaming test environment. For instance, in one embodiment, game assets of an in-development wagering game are cordoned off in a private testing environment (e.g., the game assets are stored on a private network in a testing lab and the game assets are not available for access via a public network). As shown in FIG. 1, the land-based gaming machines (i.e., gaming machine(s) 10) are for one or more in-development wagering games that are accessible to the controller 120. However, the gaming machine(s) 10 are not accessible to the user computing device 142. In other words, the user computing device 142 does not authenticate or log in to the game developer network 160. Rather, the streaming server 119 and the associated controller 120 are authorized to access the gaming machine(s) 10 (e.g., the controller 120 logs into the game developer network 160 using an authorized user account with has user rights (e.g., operating system rights) to access or communicate with a game controller of each gaming machine 10, the controller 120 accesses the gaming machine 10 via an authorized API call, etc.).

In some embodiments, the controller 120 generates video and audio streams using one or more audio coding formats, such as the MP3, Vorbis, AAC and Opus formats and/or video coding formats such as the H.264, HEVC, VP8 and VP9 formats. The controller 120 can further encode audio and video streams and assemble them into a container multimedia stream using, for example, one of the following formats: MP4, FLV, WebM, ASF, ISMA, etc. The multimedia stream is delivered from the streaming server 119 to a streaming client (e.g., user computing device 142) using a transport protocol, such as the Real-Time Messaging Protocol (RTMP) or the Real-Time Transport Protocol (RTP). In one embodiment, the controller 120 uses an HTTP-based adaptive bitrate streaming communications protocol, such as the HTTP Live Streaming (HLS) protocol., the Smooth Streaming protocol, the HTTP dynamic streaming (HDS) protocol, the Dynamic Adaptive Streaming over HTTP (DASH or MPEG-DASH), etc. In one embodiment, the streaming client (e.g., the user computing device 142) may interact with the streaming server 119 using a control protocol, such as the Microsoft Media Server (MMS) network-streaming protocol or the Real Time Streaming Protocol (RTSP).

Referring again to FIG. 3, the flow 300 continues at processing block 304, where a processor transmits, via a communications network, a video stream to a user computing device external to the secure gaming test environment for presentation via a screen of the user computing device. In one embodiment, the user computing device is a mobile device (e.g., a smartphone, a tablet, a personal mobile device, etc.) which is associated with a player (e.g., a player account, subscriber profile, etc.) associated with the gaming test environment 130 (e.g., see FIG. 1). The mobile device may be configured to present a mobile application (e.g., the gaming channel application) from which a registered player can provide user input. In one embodiment, the mobile application can communicate with the controller 120 via an application programming interface (API) developed using a software development kit (SDK) (e.g., of gaming machine 10) for purposes of communication with one or more gaming machines (e.g., for communication with a game controller or game-logic circuitry of gaming machine 10, with a bank controller for a plurality of gaming machines, etc.). In some embodiments, a mobile application is also referred to herein as the gaming channel application. In one embodiment, the testing player installs the gaming channel application on their mobile device to receive a live feed of a game in development (i.e., an in-development wagering game). The mobile device feeds a live stream of the in-development wagering game via the gaming channel application.

In one embodiment, the processor (e.g., controller 120) schedules and coordinates a presentation of a game for a particular player or group of players. For example, the controller 120 can invite a group of players to view and test a game having a community game feature. Each separate player can log in via the gaming channel application during the scheduled period to ensure that all players are playing the game at the same time, thus emulating the game experience for a community game feature as it would be presented for a group of players in a land-based casino environment. In one embodiment, the controller 120 can select the testing audience by selecting players via iGaming venues based on game play history (e.g., to select top tier players). The gaming channel application provides the selected players early access to the in-development games.

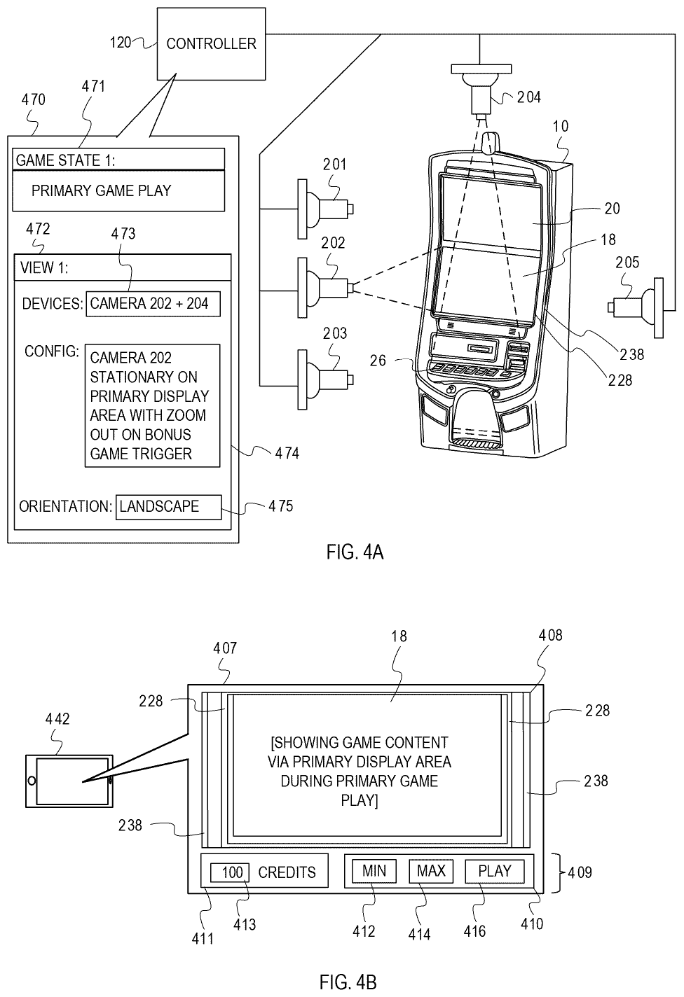

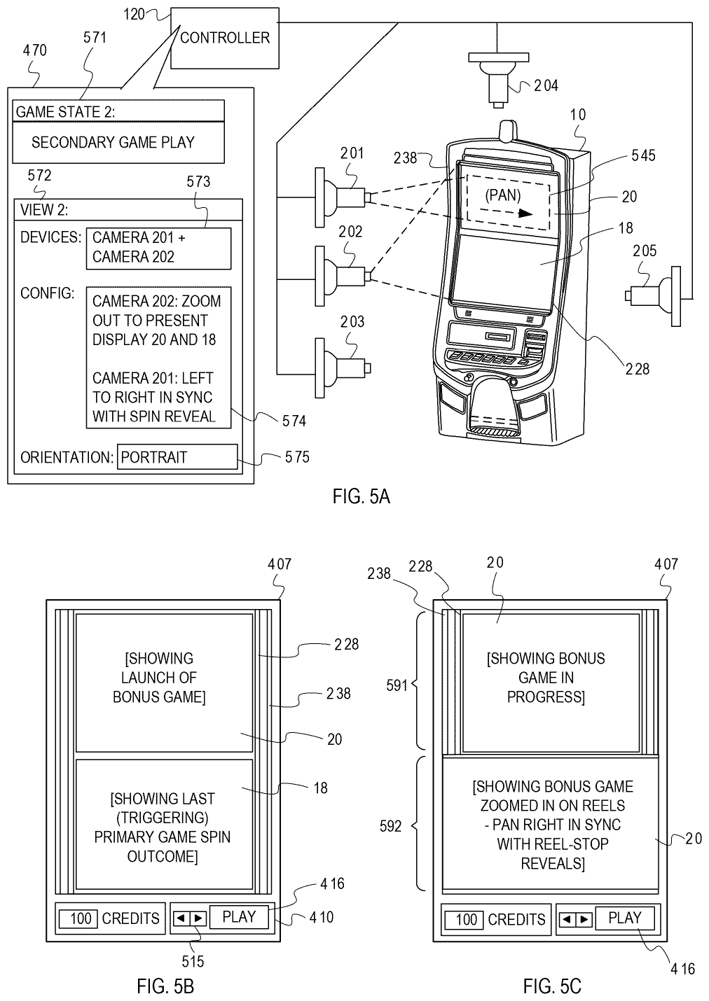

In one embodiment, the gaming channel application selects, as an initial or default view, a view that is specific to the particular in-development wagering game to be presented. When a player first accesses the in-development wagering game, the controller 120 presents, as a default view, any specific section or area of the gaming machine that is specific to the particular in-development wagering game. For example, the controller 120 detects, based on information obtained from a game controller (or other source), a type of wagering game being presented and the presentation requirements of the game play mechanic for that type of wagering game. For example, the in-development game may be a type of game that uses a primary presentation device to present primary game play and only uses a secondary presentation device when a bonus feature is triggered for the game. Hence, an initial or default view for that game may include a view that focuses on (i.e., substantially fills the view with) a streaming image of what is presented on the primary presentation device. For example, as shown in FIG. 4B, the user computing device 142 can be mobile device 442. Mobile device 442 includes a display (e.g., screen 407) that presents a view associated with an initial game state. For example, in FIG. 4B, the gaming channel application shows a view containing a stream of at least the primary presentation device 18 via which primary game content is presented during primary game play. In another embodiment, the initial game state includes a view of both the primary presentation device 18 and the secondary presentation device 20, however, when game play begins, the controller 120 can switch the initial view (which initially shows both the primary presentation device 18 and the secondary presentation device 20) to another view that focuses on the primary presentation device 18 (until a secondary game feature is triggered that requires use of the secondary presentation device 20 after which the controller 120 selects a second view that shows both presentation devices—e.g., see FIGS. 5B and 5C). FIGS. 4A and 4B illustrate a first game state (e.g., “game state 1” which refers to a game state for “primary game play”). The controller 120 can present, as a first view, the view shown in FIG. 4B. However, at a later point (based on a change in game state), the controller 120 will select a second view based on occurrence of a game state that triggers the secondary game feature. The controller 120 modifies the stream to show the second view (as illustrated in FIG. 5B and FIG. 5C). In one embodiment, the controller 120 performs various levels of views that represent degrees of zoom out from the default view. For example, the default view shows the primary game state. A secondary game view zooms out from the primary game view to a larger view that presents content for a secondary game feature. A communing game view zooms out further to show a community game feature across multiple gaming machines. After completion of the feature presented in a zoomed out view, the controller 120 automatically returns the stream to a zoomed in view, such as a cabinet view that shows a win rollup which includes a celebratory effect for a win in a feature and addition of credits to the credit meter. After detecting the completion of the win rollup the game controller 120 zooms in again and returns the stream to the default view (e.g., a primary game view of the reels). A view can include both images of areas of the gaming machine that present game content and areas that present environmental gaming effects. For example, the first view illustrated in FIG. 4B shows a depiction of what appears on the primary presentation device 18 as well as the portion of the gaming cabinet that includes emotive lighting devices 228 and 238 which surround the edges of the primary presentation device 18. For instance, section 408 of the display screen 407 includes both a view of game assets presented via the primary presentation device 18 (e.g., game symbols, or other game assets, that display game randomly determined game outcomes and accompanying graphical effects) as well as a view of the accompanying emotive lighting effects, which occur via emotive lighting devices 228 and 238 in response to game play activity during the primary game feature. A view can also incorporate sections (e.g., sections 410 and 411) which, in some embodiments, can include streams of other areas of the gaming machine 10 related to user input, game meters, game messages, etc. For instance, in one embodiment, the gaming channel application includes a banner 409 that presents a play button 416 and a credit meter 413. In one embodiment, the player button 416 and/or credit meter 413 may be graphically generated by the controller 120 and presented within sections 410 and 411 respectively. In another embodiment, however, section 410 and section 411 may be streamed images of areas of the gaming machine 10 that include images of a button/button panel or a credit meter of the gaming machine 10 (e.g., as captured by camera 204 or camera 202 respectively). For instance, section 410 may include a live stream of one or more of the buttons 26 from a physical button panel of the gaming machine 10. In one embodiment, the controller 120 zooms camera 204 onto the buttons 26. In one embodiment, the controller 120 crops portions of the stream related to certain ones of the buttons 26. The controller 120 can construct the view of the buttons 26 to include the one or more zoomed and/or cropped portions of the stream of the button panel (e.g., to show a portion of the available buttons on the button panel (e.g., the min bet button 412, the max bet button 414, the play button 416, etc.). In one embodiment, the gaming channel application presents a view that has a user-interface control, such as a scroll button (e.g., see scroll control 515) that transmits instructions to the controller 120 to zoom in camera 204 and/or to pan left/right, in response to a scrolling input received via the scroll control 515 (which scrolling input indicates either a left direction or a right direction), causing the controller 120 to modify the view for the stream within section 410 to pan left or right based on a direction indicated by the user input. Furthermore, the screen 407 of the mobile device 442 includes touch-screen functionality. Thus, the controller 120 can detect a touch input over the particular buttons shown via screen 407 then transmit an appropriate command or instruction to the gaming machine 10 based on the location of the touch input detected via the screen 407. Additionally, the banner 409 may include a credit meter 413 that shows a balance of playing credits. In one embodiment, the section 411 is a live stream of a credit meter of the gaming machine 10 (e.g., captured by camera 202 from the primary presentation device 18). The player can initiate a test play of the game by using a credit (e.g., a sample bet).

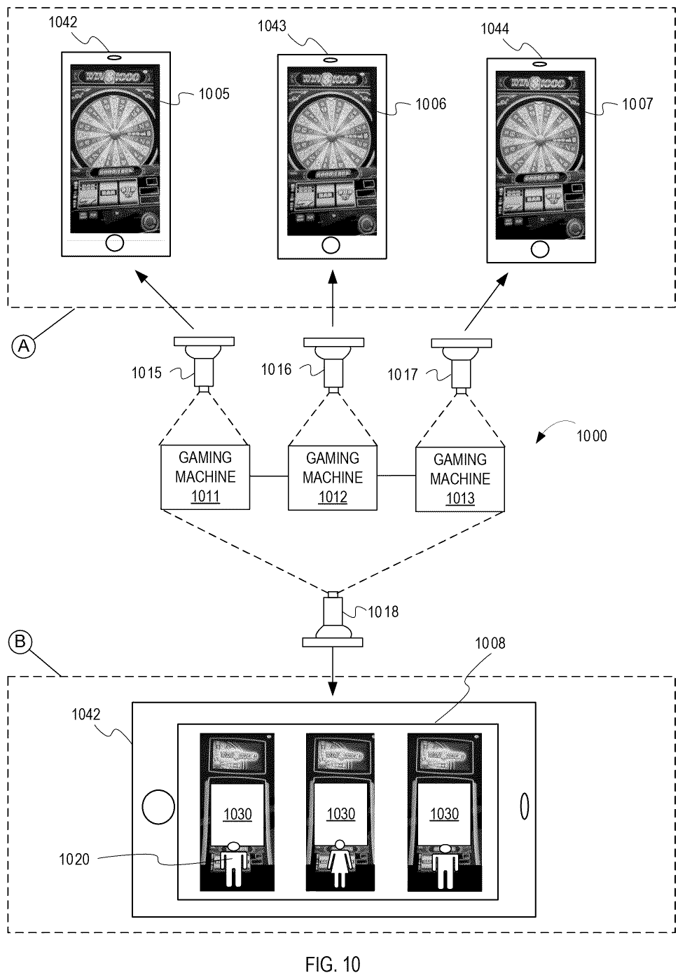

In some embodiments, the controller 120 superimposes a virtual overlay onto the gaming channel application onto which the controller 120 presents additional content (e.g., content related to game play, content related to players of the game, content related to a spectator of the game, etc.). For instance, the controller 120 graphically generates and presents (animates via the virtual overlay) the player button 416 and/or credit meter 413. In response to detecting a user input of a virtual play button (e.g., button 416), the controller 120 transmits the instruction to game-logic circuitry (e.g., game-logic circuitry 840) of the associated gaming machine. In another example, the controller 120 animates an avatar (e.g., an animated outline, a shadow image, etc.) of a player located at a gaming machine (e.g., avatar 1020 of each individual player located at each of the gaming machines 1011, 1012, and 1013 located at bank 1000 as shown in FIG. 10). The avatar indicates use of the gaming machine by a user. Further, the avatar emulates the look and feel of a bank of machines at a casino, where occupied gaming machines have players seated in front of them. The avatar may be transparent to a certain degree so as to prevent blocking a view or to permit viewing of at least some of a portion of content over which the avatar is superimposed. In some embodiments, the controller 120 can generate the avatar based on information obtained from a user account. For example, the controller 120 can detect a physical characteristic of the user (e.g., a gender identifier specified in the user account, a description of an appearance of the user, a physical attribute such as hair or eye color, an article of clothing, etc.) and can modify the avatar to appear representative of the physical characteristic. In another example, the controller 120 can use an image of a user to generate and/or animate (e.g., using generative artificial intelligence, machine-learning models, etc.) the avatar to have some similarity to the characteristic of the user.

Referring again to FIG. 3, the flow 300 continues at processing block 306, where a processor conducts, in response to a user input received from the user computing device after transmitting the video stream, play of the in-development wagering game presented via the first view. For example, referring to FIG. 4B, in response to detection of user input within section 410, such as selection of the button 416, the controller 120 determines that the in-development wagering game is in the first game state for play of a primary game. Hence, the controller 120 selects the first view based on the first game state. In one embodiment, the controller 120 selects the first view in response to determination of the first game state based on analysis of game play (e.g., based on tracking of game events). In one embodiment, the controller 120 references a view configuration library (library 470) which specifies a plurality of game states and their respective view configurations. The library 470 includes an identifier 471 of the first game state and corresponding view configuration settings 472. The view configuration settings 472 may include device information 473 (e.g., referring to the image-capture devices used to generate the first view), image-capture instructions 474 (e.g., referring to image capture actions, movements, etc., associated with image-capture devices indicated in the device information 471), an orientation 475 (e.g., referring to the layout orientation of the first view for the dimensions of the screen 407 of the mobile device 442), etc.

Referring again to FIG. 3, the flow 300 continues at processing block 308, where a processor detects, in response to analysis of game play, a change in state, related to presentation of the in-development wagering game, of either the gaming machine or the user-computing device. In some embodiments, the processor determines a change in game state in response to analysis of game play (e.g., in response to analysis of an event log of the gaming machine 10, in response to communication with game-logic circuitry, etc.). In some embodiments, the processor determines, in response to processing (e.g., analyzing) signals received from a sensor of the user computing device, a change in physical state of the user computing device. The change in physical state can include, but not be limited to, detecting a change in an orientation, direction, motion, acceleration, etc. of a user computing device. In some embodiments, the processor receives communications from the gaming channel application regarding the change in physical state of the user computing device (e.g., regarding a change in orientation of a mobile device from a portrait view to a landscape view or vice versa; regarding a change motion of the mobile device (e.g., relative to a face of the user); regarding a change in acceleration of the mobile device, etc.). The processor can communicate with one or more sensors, such as, but not limited to: a gyroscope (e.g., a micro electro mechanical systems gyroscope), an accelerometer, a position sensor (e.g., a global positioning system (GPS) chip, a Wi-Fi tracking device, a barometer, a compass, etc.), an image sensor (e.g., a camera of the mobile device, a luminosity sensor, a depth/range sensor (e.g., light detection and ranging (LIDAR) device), and so forth. In another embodiment, the processor determines a manual user override that changes the state of the camera views from a default view to a user-selected (preferred) view.

In one example, the controller 120 detects a change from a first game state to the second game state. For instance, the controller 120 receives game information (e.g., key game events) from the gaming machine 10 (e.g., for the particular game being played at the gaming machine 10), which the controller 120 uses to determine the current game state and/or to anticipate or evaluate the automated modifications to be made to the view (e.g., the controller 120 anticipates the actions (e.g., adjustments, movements, etc.) required to modify a first view to a second view, and changes the location and focus of the streamed content to show areas of the gaming machine 10 for the second view). In other words, by knowing the details of the key game event, the controller 120 can thus adjust movements, actions, settings, etc. of the streaming equipment (e.g., the image-capture array 122) to specifically create a required view of the corresponding game content of the key game event. For example, the controller 120 uses the game event information to intelligently select the portions of the gaming machine 10 to display and to plan for the corresponding camera motions/actions. Some examples of the controller 120 using the game event information to plan and/or select a view includes, but is not limited to, the following: the controller 120 can determine required adjustments to pan and/or tilt settings of a motorized camera required to focus in on appropriate portions of the gaming machine display area associated with a key game event; the controller 120 can determine to move a camera across a screen to capture video of a series of effects that occur for a specific key game event; the controller 120 can determine to select proper lighting or graphic display levels for presentation of gaming content in areas of a display related to a key game event; the controller 120 can determine to present images of input controls (e.g., button panels, user-interface controls, etc.) associated with (e.g., required to activate or respond to) the key game event; the controller 120 can detect a timing for how long to track and/or present game content, emotive lighting effects, environmental object activity, etc., and so forth.

In one example, the controller 120 detects (in response to communication with a game controller, game-logic circuitry, etc. of the gaming machine 10) a key event from the in-development wagering game that causes a change in game state, such as detecting a trigger occurring for a secondary game feature (e.g., a bonus game). The key event (e.g., the triggering event) causes a change from the first game state (e.g., the primary game play) to the second game state (e.g., the secondary game play). The transition between the first game state to the second game state may be considered, in one embodiment, to be part of the second game state. In another embodiment, the transition between the first game state and the second game state may be considered an additional game state which may require an additional, different view or view configuration setting (during the transition) than either the first view of the second view.

Referring again to FIG. 3, the flow 300 continues at processing block 310, where a processor determines, based on the change in state (e.g., a change in game state of the game, a change in physical state for the user computing device, a manual override change of views, etc.) a second view of the land-based gaming machine to present to the user computing device, the second view being different from the first view.

Further, in response to the processor determining the second view, the flow 300 continues at processing block 312, where a processor automatically modifies the video stream to present the second view.

For example, in FIG. 5A the controller 120 detects a triggering event for the second game state (e.g., a special symbol lands in an array of symbols presented for the primary wagering game, a specific winning outcome occurs for the primary wagering game, etc.). In response to detecting the triggering event, the controller 120 detects that the in-development game has entered a second game state. The controller 120 finds, based on a search of the library 470, an identifier 571 for the second game state. The controller 120 further determines, within the library 470, respective view configuration settings 572 that correspond to identifier 571 for the second game state. The view configuration settings 572 include device information 573 (e.g., referring to the image-capture devices used to generate the view for the second game state), image-capture instructions 574 (e.g., referring to image capture actions, movements, etc., associated with image-capture devices indicated in the device information 573), an orientation 575 (e.g., referring to the layout orientation of the second view for the dimensions of the screen 407 of the mobile device 442), etc.

In one example, the controller 120 causes any image-capture devices indicated in the device information 573 to change its zoom and shift its focus onto parts of the slot cabinet depending upon the current state of slot play. For example, during the first game state, the controller 120 caused one or more of the cameras 201 and/or 202 to focus on a primary presentation area (e.g., located on a lower display or a lower portion of a tall display) during a base game played via a primary presentation area (e.g., see FIG. 4B). Referring to FIG. 5B, in response to a bonus feature being triggered (e.g., triggered via play of the primary game as presented in the primary presentation area 18), the cameras 201 and/or 202 move or adjust to present an additional display area (i.e., secondary presentation area) that presents the triggered game feature (e.g., the camera 202 adjusts (e.g. moves, zooms out) to view the secondary presentation device 20 in addition to the primary presentation device 18). In the example shown in FIG. 5B, the controller 120 selects a transitional view that has a portrait orientation (as presented via the screen 407) and which presents the primary presentation device 18 and the secondary presentation device 20, as well as any accompanying emotive lighting devices (e.g., emotive lighting devices 228 and/or 238), which are associated with the presentation of the secondary game play. The primary presentation device 18 shows the triggering event that occurred during the primary game play (e.g., shows the last spin outcome that occurred for the primary game play, which triggered the secondary game feature). The secondary presentation device 20 shows a launch sequence and/or launch effects that occur when the secondary game feature is initially presented during the launch of the bonus game feature. Consequently, the player may initiate play of the bonus game (e.g., in response to selection of the play button 416, in response to a selection of a graphical button presented via a display device, etc.). The controller 120 can then cause the camera 202 to transition to the second view, such as by zooming in and focusing on a secondary presentation area (e.g., zooms in on an upper “secondary” display such as the secondary presentation device 20, zooms in on an upper portion of a tall display where the bonus game is presented, etc.). FIG. 5C illustrates an example of the second view as presented via the screen 407. The second view divides the screen 407 into multiple content-presentation sections, where an upper section 591 shows the entire secondary presentation device 20 as well as surrounding emotive lighting devices 228 and 238. For example, controller 120 instructs the camera 202 to focus on the secondary presentation device 20 and the surrounding portions of the gaming machine 10. A lower section 592 shows a zoomed in portion of the secondary presentation device 20. For example, the controller 120 instructs the camera 201 to zoom in on reels (or other game play elements) presented via the subsection 545 of the secondary presentation device 20 during the secondary game play. The gaming content displayed in the subsection 545 is presented via the view presented in the lower section 592.

In another example, the controller 120 may detect a community gaming event. The controller 120 can change the stream from a first view that shows only the display areas of one gaming machine 10 to instead be a second view that shows the community game feature (e.g., the controller 120 can zoom out the camera(s), or switch to a bank camera-array configuration) to show a bank of gaming machines or to show multiple display areas linked to other players involved in the community game event).

For example, FIG. 10 illustrates an example of dynamically controlling modification of a view for a bank of gaming machines within a gaming test environment. In one example, in FIG. 10, at stage “A,” a processor (e.g., the controller 120) presents a first view 1005 of a first gaming machine 1011. The first view 1005 is for play of a game or feature controlled by the first gaming machine 1011. The processor streams, to user computing device 1042 (similar to mobile device 442) the first view 1005 for presentation via the gaming channel application running on the user computing device 1042. The processor also streams different views (e.g., second view 1006 and third view 1007) to respective user computing devices 1043 and 1044 for presentation of different test gaming sessions via respective instances of the gaming channel application. The gaming machines 1011, 1012, and 1013 are part of a bank of gaming machines (bank 1000). As shown in FIG. 10, the first view 1005, the second view 1006, and the third view 1007 appear similar (e.g., gaming machines 1011, 1012, and 1013 are in a similar game mode, such as playing a primary game, thus are each presented an animated primary game view). However, each of views 1005, 1006, and 1007 may be in a different game state (e.g., one may be in primary game mode, whereas others may be in a secondary feature mode). Further each gaming machine can present different user data and or session data (e.g., different meter counts, different random game outcomes, etc.) depending on the details of each individual gaming session for each of the players. Thus, because the views 1005, 1006, and 1007 have some possible differences and/or are associated with different gaming machines, they are described herein as different views.

Still referring to FIG. 10, at stage “B,” (subsequent to stage “A”) the processor detects that a game event occurs via the first gaming machine 1011, which triggers a feature that is relevant across the bank 1000. The processor changes the first view 1005 to be a fourth view 1008 (also referred to as a “community view” 1008), which presents a community gaming feature via a screen of the user computing device 1042. In FIG. 10 the fourth view 1008 is illustrated as presented on user computing device 1042, however (though not shown for sake of brevity) the user computing devices 1043 and 1044 also present the view 1008 concurrently via their respective screens. The processor obtains the first view 1005 via a first camera 1015, which is associated with (e.g., centered on) the first gaming machine 1011. Likewise, the processor obtains second view 1006 via a second camera 1016, which is associated with (e.g., centered on) the second gaming machine 1012. Furthermore, the processor obtains third view 1007 via a third camera 1017, which is associated with (e.g., centered on) third gaming machine 1013. The processor will also, in response to the trigger for the community feature, incorporate the second gaming machine 1012 and third gaming machine 1013 into the community game feature as they are being played at the bank 1000 when the trigger occurred. In one embodiment, the processor switches (in response to the triggering event) the streams of views 1005, 1006, and 1007 to community view 1008, such as by switching the individual streams of the views 1005, 1006, and 1007 to a stream of the community view 1008 recorded by a fourth camera 1018 (also referred to as a “community camera” 1018) that records and provides the community view 1008 to the processor for streaming to the user computing devices 1042, 1043, and 1044. The community view 1008 presents a view of the three gaming machines 1011, 1012, and 1013 besides each other and the upper screens of the machines present one animation 1030 related to the community game feature (e.g., a bonus event related to the entire bank 1000, where all players of the gaming machines 1011, 1012, and 1013 are participating in a test gaming session for a game linked to the community feature). In one embodiment, the processor can provide a spectator view related to a spectator mode. For instance, in one embodiment the number of gaming machines in the bank 1000 are fewer than a number of player accounts that are waiting to play the game. For example, additional player accounts are connected to the streaming server 119 via a gaming channel application and awaiting (i.e., are queued up) in a virtual lobby of the gaming channel application for a turn to play one of the gaming machines 1011, 1012, or 1013 in the bank 1000. The processor can, thus, enable a spectator mode for each of the awaiting additional player accounts, where each additional player account that enters the spectator mode can view the community game feature (e.g., view 1008 and/or animation 1030) as a spectator (e.g., via the use of the community camera 1018 or via any other camera associated with the bank 1000, such as a camera that the spectator chooses). In one embodiment, the user interface of the gaming channel application can animate options to select and/or switch to the different views. In one embodiment, the options to select or switch views are made available to all player accounts, including during community game features and/or during individual gaming session features (e.g., a player account can manually select to override a default view presented by the processor if permitted by the processor based on any game constraints or priority events that would prevent the change in view). The spectators, however, do not interact with a gaming machine while in the spectator mode. In one example, the processor can determine that a manual user override changes the state of the camera views to a preferred view. In some embodiments, the gaming channel application animates one or more options (e.g., buttons, interface controls, etc.) that permit the user to override the dynamic view modification (i.e., override the automated context-aware view switching and/or modifications) and the user can select a view that they prefer. In some embodiments, the override is constrained by one or more constraint requirements of the testing environment, the game features, the gaming machine, etc. For example, the override options are available so long as, based on the current or anticipated state of the game, the user computing device can present sufficient detail to view or evaluate the presented gaming content. For instance, the controller 120 may prevent a manual override to select a community view if the community view would present the gaming content (i) at a size that is smaller than a minimum screen area size for the gaming content, (ii) at lower than a minimum resolution for the gaming content, (iii) with less than a minimum text legibility for the gaming content, (iv) etc.

In addition to modifying a view of the gaming content, the controller 120 can further adjust the audio accordingly. For example, in one embodiment, the controller 120 can obtain an electronic audio feed of the gaming content directly from a game controller and can provide the audio feed to the gaming channel application to play via speakers of the user computing device 142. The audio feed can be synchronized with presentation of the video feed of the gaming content.

Furthermore, in some embodiments, the controller 120 can obtain an emotive lighting feed and can provide the emotive lighting feed to the gaming channel application to play via a portion of the screen associated with the emotive lighting patterns, colors, etc., thus causing the emotive lighting characteristics of the gaming machine to be more viewable via the screen 407 of the user computing device 142. For example, the screen 407 may present a rectangular highlight section (e.g., an effects frame) that surrounds a stream of a video feed of one or more portions of the gaming machine 10. The controller 120 can receive emotive-lighting data (e.g., light effect patterns, colors, timing, etc.) for any emotive lighting effects that occur during the game play. The mobile device 442 presents, via the screen 407, a graphical representation of the emotive-lighting data via the effects frame.

In one embodiment, the controller 120 is configured to communicate with a player interface device that is communicatively coupled to a game controller of the gaming machine 10. In some embodiments, the player interface device can intercept an image feed of gaming content from the game controller and rescale the gaming content to fit as a picture-in-picture within a player user interface that presents system-based content, such as content related specifically to a player account (such as customer loyalty benefit information, earned rewards points, player funds, promotions, bonus games, etc.). In some embodiments, the controller 120 can use the player interface device to communicate with the game controller (e.g., to detect game events, to obtain screen information data about game play, to scale or rescale gaming content, etc.). The player interface device can also provide access to a player account to store credits or points (e.g., via a Casino Management System (CMS)) for use on a land-based gaming machine within a casino. The stored credits or points can be used to obtain casino services such as electronic drink deliveries, ordering tickets to casino entertainment, redeeming rewards, etc. In some embodiments, the player interface device is an iView® player interface product by Light & Wonder, Inc. An example description of the iView® product can be found in U.S. Pat. No. 8,241,123 to Kelly et al., the entirety of which is hereby incorporated by reference.

In some embodiments, a gaming system or network (e.g., gaming network 100, gaming server 119, etc.) incorporates a video recording system that allows automatic recording of views of live-streamed gaming content so that, in the case of a data communication error (e.g., data loss, stream corruption, communications dropout, etc.) the portion of the affected data stream can be played back (e.g., via the gaming channel application). For example, in some embodiments, the controller 120 records live streamed video via a media player software (e.g., VideoLAN Client (VLC) player by the VideoLAN Project), a screen recorder, etc. The controller 120 can present the stream while recording the live stream. In the case of a data communication error (e.g., data loss) during presentation of the live stream, controller 120 can replay back any recorded portions that did not get presented due to the communication error.

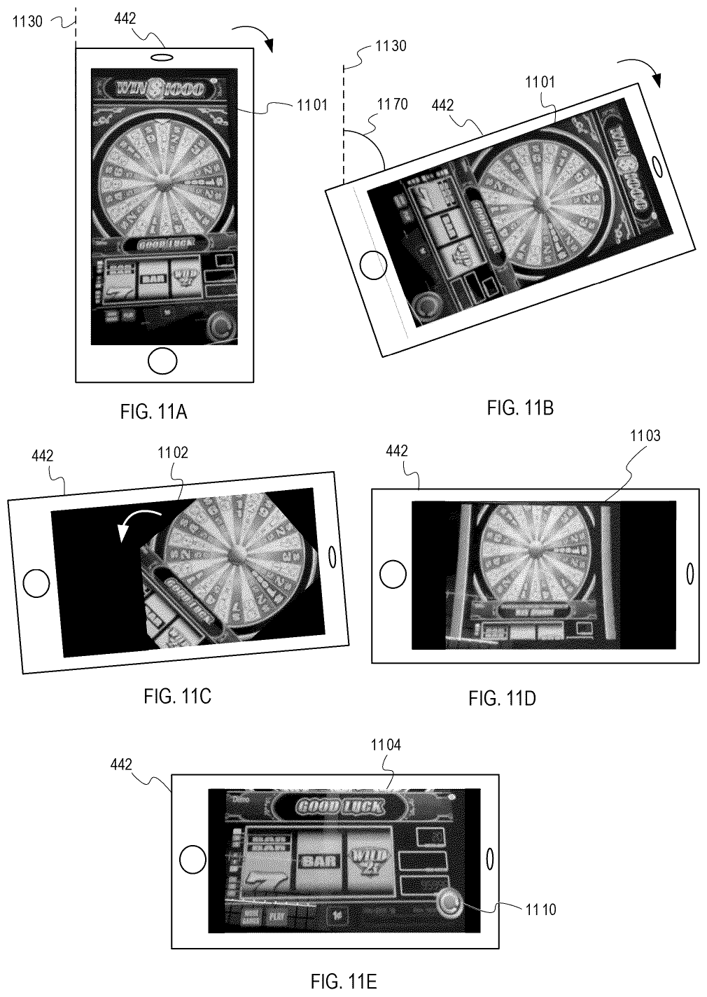

FIGS. 4A, 5A and 6A illustrated some examples of a gaming test environment that includes multiple cameras. FIG. 11A-11E illustrate an example of dynamically controlling a single camera to modify a view presented via the gaming channel application based on a change in orientation state to the user computing device. In FIG. 11A, mobile device 442 is in a portrait orientation showing a portrait view 1101 of a gaming machine. A processor (e.g., associated with the mobile device 442 and/or the controller 120) detects (e.g., via a gyroscopic sensor associated with the mobile device 442) that the mobile device 442 begins to be physically rotated to the right from an upright position 1130. In FIG. 11B, the processor detects that the mobile device 442 rotates past a certain angle 1170 from the upright position 1130. In response to detecting that the mobile device 442 rotates past the certain angle 1170, as shown in FIG. 11C, the processor communicates to the single camera (positioned in front of the gaming machine) to begin a zoom in which will modify the portrait view 1101 to a different view configured for a landscape orientation. The processor further replaces the portrait view with a transitional view 1102. The transitional view 1102 zooms in to a first level and rotates the portrait view 1101 to the left (in contrast to the physical rotation of the mobile device 442 to the right). In FIG. 11D, the processor detects that the mobile device 442 has been rotated completely, and the processor presents a third view 1103 (i.e., which is a modification of the view 1011 zoomed in to the first level). In response to presenting the third view 1103, the processor causes the camera to further zoom in to landscape view 1004. In addition, the processor animates (via a graphical overlay) one or more virtual controls, such as play control 1110.

In one example, a change in orientation, such as from a portrait view to a landscape view, changes to a different aspect ratio that can present more content horizontally on the screen of a user-computing device, but which also reduces presentation of more content vertically on the screen (i.e., the aspect ratio of the landscape view has a larger horizontal aspect ratio value than a portrait view). Thus, the controller 120 detects the change in orientation and modifies the view based on the space available. For instance, (e.g., see FIG. 11A) the view presented for a portrait orientation may include a view of both the reels and an upper screen (e.g., a view of a wheel used in a secondary game feature). When the orientation of the user computing device changes, the controller 120 detects that content for an upper screen of the gaming machine is not completely viewable due to the reduction in the vertical aspect ratio value of the landscape view. Thus, in response to detection of the change to the landscape view, the controller 120 removes presentation of the upper screen by zooming in (e.g., see FIGS. 11C, 11D, and/or 11E) presenting a wider view of the relevant content for the primary game (e.g., the reels) within the landscape view.

Referring again to FIG. 3, the flow 300 continues at processing block 314, where a processor detects whether user-related feedback is provided. If, at processing block 314, the processor detects user-related feedback, the flow 300 continues at processing block 316, where a processor uses the user-related feedback for modification of the in-development wagering game prior to the game being submitted to a jurisdictional gaming approval procedure. For instance, the players (and/or spectators) who use the gaming channel application can provide feedback (e.g., directly or indirectly) regarding the in-development wagering game. The controller 120 can detect (e.g., deduce) indirect user feedback based on various factors such as, but not limited to, an amount of time the game is played by a player, a degree of progress made in attaining a game goal or objective (e.g., a level of winning, a level of losing, etc.), a level of user engagement (e.g., a level of betting, a level of viewing, etc.), a detection of a user emotion (e.g., detection of user emotions based on machine-learning analysis of facial, or other bodily, expressions or gestures made by the player or spectator during play), etc. In another example, the controller 120 can change the view to present various proposed game elements to assess a level of user interest or preference (e.g., to determine which of the proposed game elements the user appears to react to most favorably). For example, the controller 120 can automatically modify characteristics (e.g., colors, artwork, bonus features, etc.) of some game assets or other game content associated with the in-development wagering game and then detect (and/or deduce) a user response to the modification. The controller 120 can detect a favorable user response in various ways such as, but not limited to, determining an increase to an amount of time the game is played by a player, detecting an increase to a level of betting, detecting (based on machine-learning analysis) that a player expresses a happy or pleased emotion during play, etc.

In some embodiments, the controller 120 gamifies the feedback process, such as by selecting and/or creating gamified incentives (e.g., rewards, challenges, quizzes, etc.), which can be used to entice access or use of a specific game feature, to evoke or detect a level of user satisfaction associated with a specific game feature, etc.

In other embodiments, the controller 120 can also directly ask for or otherwise illicit direct feedback from the user, such as by asking a specific question or series of questions about the presented game content/features, by highlighting a certain portion of the presented view to specify a game feature in question, by asking follow-up questions to detected user actions, etc. For example, the controller 120 can present a user interface that presents a question or survey of questions as well as a graphical overlay to highlight, via the screen of the user computing device 142 (e.g., via screen 407), an area or portion of the game display where the game feature in question is presented. In another example, the controller 120 can detect a lack of interest (e.g., a player quickly stops playing the game), and, in response, the controller 120 can ask a question, such as whether the player had seen a certain game feature and/or whether the controller 120 can modify the view of the gaming content to provide a second chance to experience the feature. The game developer (e.g., the studio who is creating the game) can use the feedback to make development adjustments to improve game play. For example, the controller 120 detects a lack of player engagement (e.g., the controller 120 detects that the player is not using all of their credits to play the game or their time on device is short, which indicates a degree of lack of engagement or a possible game issue or error). The detected feedback (e.g., of lack of player engagement) indicates that the game, or some aspect of the game, needs potential improvement.

Furthermore, the controller 120 can automatically provide rewards or other incentives, such as coupons, online game credits, reward or casino-loyalty account points, etc., in return for testing certain features, for providing feedback about certain features, for inviting friends (e.g., via social media channels), etc. The controller 120 can access various user accounts related to a user, such as third-party accounts, player loyalty accounts of specific casinos (e.g., accesses CMS), online retailer accounts (e.g., for Amazon.com), online game provider accounts (e.g., for SciPlay.com), etc. The controller 120 can access incentive structures, models, etc. from the various entities and/or sources (e.g., networks, servers, etc.) associated with the various user accounts. In some embodiments, the controller 120 can convert incentives across the user accounts. In some embodiments, the controller 120 can detect a user location (e.g., a GPS location of the mobile device 442) in order to select and/or provide a given incentive to test the game and/or to provide feedback associated with the game testing, which incentive is related to a GPS location of the mobile device 442. For example, the controller 120 can provide incentives associated with the CMS that is closest geographically to the mobile device 442 at the time the in-development wagering game is tested. The controller 120 can add earned incentive rewards (e.g., in the form of loyalty points) to a customer loyalty account of a casino operator that controls the CMS.

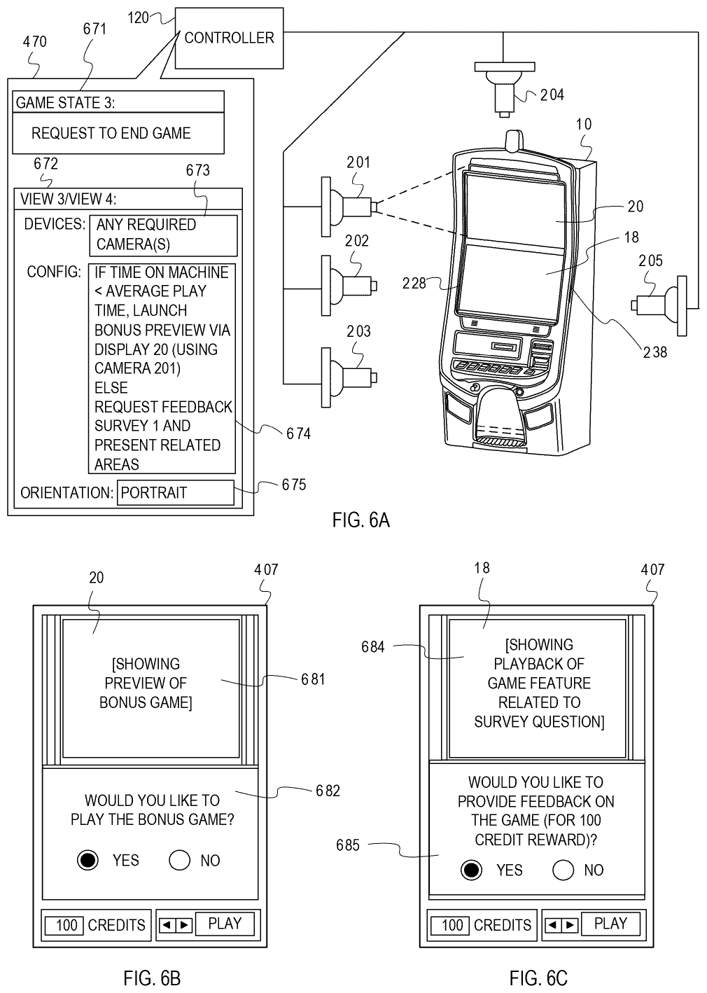

FIGS. 6A, 6B and 6C illustrate an example of changing a streamed view to request or determine user-related feedback. The controller 120 detects a third game state 671 for the in-development game. Specifically, the controller 120 detects a request, from player input, to end the game, such as a selection of a back button or menu button on the gaming channel application, a selection of a “cash out” button via a stream of the gaming machine 10, selection of a window collapse/exit control associated with the user computing device 142, etc. In response to detecting the request to end the game (e.g., the third game state), the controller 120 finds, based on a search of the library 470, an identifier 671 for the third game state. The controller 120 further determines, within the library 470, respective view configuration settings 672 that correspond to identifier 671 for the third game state. The view configuration settings 672 include device information 673 (e.g., referring to the image-capture devices used to generate one or more additional views for the third game state), image-capture instructions 674 (e.g., referring to image-capture actions, movements, etc., associated with image-capture devices indicated in the device information 673), an orientation 675 (e.g., referring to the layout orientation of the one or more additional views for the dimensions of the screen 407 of the mobile device 442), etc. For example, the image-capture instructions 674 include logic that the controller 120 uses to for generating the one or more additional views for the third game state. For instance, the logic indicates that if the player did not get to experience the bonus game feature (e.g., the time spent playing the gaming machine 10 is less than an average amount of time, such as if the player tries to close the game before triggering the bonus game feature), the controller 120 can present a message 682 that asks whether the player would like to experience the bonus game feature. If user input via the message 682 indicates a desire to view the bonus game feature, the controller 120 generates a third view 681, as shown in FIG. 6B, which depicts a preview of the bonus game via secondary presentation device 20. Furthermore, the logic within the image-capture instructions 674 may determine to present a survey of questions about the player's experience testing the in-development wagering game. For example, as shown in FIG. 6C, the controller 120 presents, via the gaming channel application, a message 685 that asks the player whether they would like to provide direct feedback related to the game. The message 685 may also include an incentive, such as a reward of credits or points, for providing the feedback. The controller 120 can change the area where the message 685 is presented to ask specific questions about a given game feature. The controller 120 presents a fourth view of any of the specific game features that are played back via the gaming machine 10 during the survey. The fourth view may be a plurality of different areas of the gaming machine 10, where each area is related to the particular survey question. The controller 120 can detect whether the player completes the survey, and, upon completion, the controller 120 can add the offered credits or points to a credit meter of a game, to an account associated with the online gaming channel system 155, to a customer loyalty account associated with a casino management system, etc. Furthermore, based on the feedback provided, the controller 120 can provide the feedback to a game development server or other device associated with the game developer network 160. The game developer of the in-development wagering game can use the feedback to modify the gaming machine 10 and/or to modify any of the content stored and/or presented by the gaming machine 10. In some embodiments, the controller 120 can make automatic modifications to one or more aspects of the in-development wagering game based on the detected feedback.

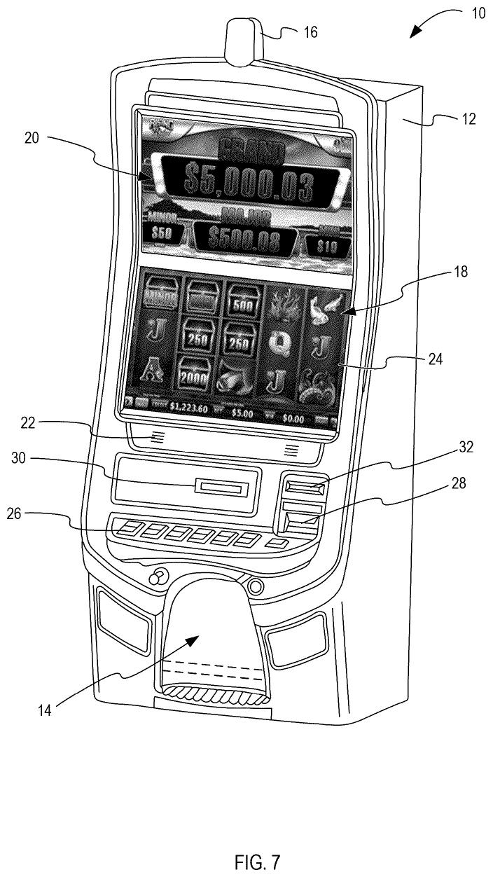

Referring to FIG. 7, there is shown a gaming machine 10 similar to those operated in gaming establishments, such as casinos. With regard to the present disclosure, the gaming machine 10 may be any type of gaming terminal or machine and may have varying structures and methods of operation. For example, in some examples, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 7 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the credits meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

FIG. 8 is diagram of a gaming-machine architecture according to at least some aspects of the disclosed concepts. Referring to FIG. 8, a gaming machine 810 includes game-logic circuitry 840 (e.g., securely housed within a locked box inside a gaming cabinet). The game-logic circuitry 840 includes a central processing unit (CPU) 842 connected to a main memory 844 that comprises one or more memory devices. The CPU 842 includes any suitable processor(s), such as those made by Intel and AMD. By way of example, the CPU 842 includes a plurality of microprocessors including a master processor, a slave processor, and a secondary or parallel processor. Game-logic circuitry 840, as used herein, comprises any combination of hardware, software, or firmware disposed in or outside of the gaming machine 810 that is configured to communicate with or control the transfer of data between the gaming machine 810 and a bus, another computer, processor, device, service, or network. The game-logic circuitry 840, and more specifically the CPU 842, comprises one or more controllers or processors and such one or more controllers or processors need not be disposed proximal to one another and may be located in different devices or in different locations. The game-logic circuitry 840, and more specifically a main memory 844, comprises one or more memory devices which need not be disposed proximal to one another and may be located in different devices or in different locations. The game-logic circuitry 840 is operable to execute all of the various gaming methods and other processes disclosed herein. The main memory 844 includes a wagering-game unit 846. In one embodiment, the wagering-game unit 846 causes wagering games to be presented, such as video poker, video black jack, video slots, video lottery, etc., in whole or part.

The game-logic circuitry 840 is also connected to an input/output (I/O) bus 848, which can include any suitable bus technologies, such as an AGTL+ frontside bus and a PCI backside bus. The I/O bus 848 is connected to various input devices 850, output devices 852, and input/output devices 854.

By way of example, the output devices may include a primary display, a secondary display, and one or more audio speakers. The primary display or the secondary display may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 810. The gaming machine 810 can also include a touch screen(s) mounted over the primary or secondary displays, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 854 include one or more value input/payment devices and value output/payout devices. In order to deposit cash or credits onto the gaming machine 810, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 810. Examples of value input devices include, but are not limited to, a coin acceptor, a bill/ticket acceptor (e.g., a bill validator), a card reader/writer, a wireless communication interface (e.g., communication device 103) for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 810. The credits may be exchanged for cash at, for example, a cashier or redemption station. Examples of value output devices include, but are not limited to, a coin hopper for dispensing coins or physical gaming tokens (e.g., chips), a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 848 is also connected to a storage unit 856 and an external-system interface 858, which is connected to external system(s) 860 (e.g., wagering-game networks, communications networks, etc.).

The external system(s) 860 includes, in various aspects, a gaming network, other gaming machines or terminals, a gaming server, a remote controller, communications hardware, or a variety of other interfaced systems or components, in any combination. In yet other aspects, the external system(s) 860 comprises a player's portable electronic device (e.g., cellular phone, electronic wallet, etc.) and the external-system interface 858 is configured to facilitate wireless communication and data transfer between the portable electronic device and the gaming machine 810, such as by a near-field communication path operating via magnetic-field induction or a frequency-hopping spread spectrum RF signals (e.g., Bluetooth, etc.).

The gaming machine 810 optionally communicates with the external system(s) 860 such that the gaming machine 810 operates as a thin, thick, or intermediate client. The game-logic circuitry 840—whether located within (“thick client”), external to (“thin client”), or distributed both within and external to (“intermediate client”) the gaming machine 810—is utilized to provide a wagering game on the gaming machine 810. In general, the main memory 844 stores programming for a random number generator (RNG), game-outcome logic, and game assets (e.g., art, sound, etc.)—all of which obtained regulatory approval from a gaming control board or commission and are verified by a trusted authentication program in the main memory 844 prior to game execution. The authentication program generates a live authentication code (e.g., digital signature or hash) from the memory contents and compares it to a trusted code stored in the main memory 844. If the codes match, authentication is deemed a success and the game is permitted to execute. If, however, the codes do not match, authentication is deemed a failure that must be corrected prior to game execution. Without this predictable and repeatable authentication, the gaming machine 810, external system(s) 860, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 842 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 842 when executing the game-outcome logic to determine a resultant outcome for that instance of the wagering game. The resultant outcome is then presented to a player of the gaming machine 810 by accessing the associated game assets, required for the resultant outcome, from the main memory 844. The CPU 842 causes the game assets to be presented to the player as outputs from the gaming machine 810 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 810 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 810 may include additional peripheral devices or more than one of each component shown in FIG. 8. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

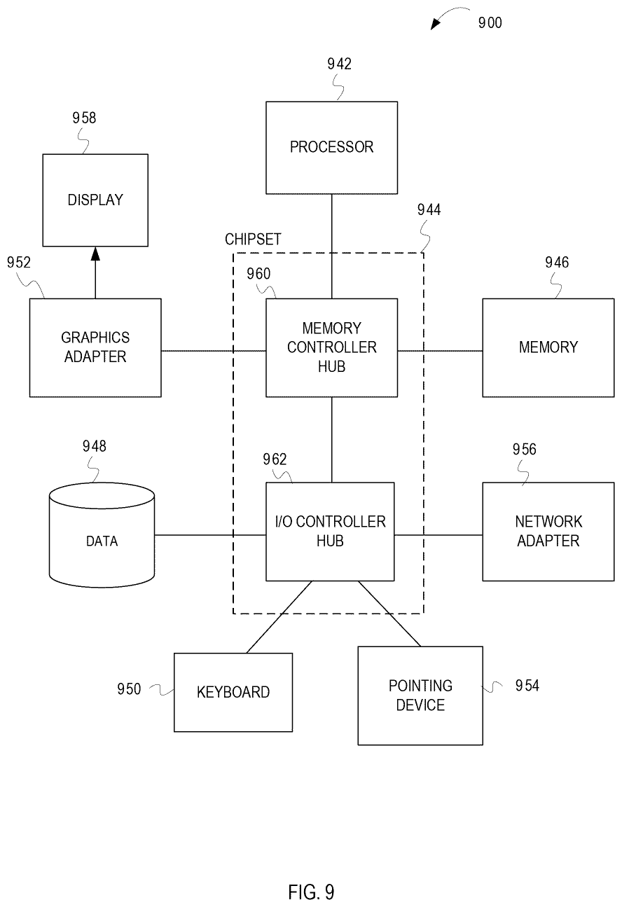

FIG. 9 is shown a block diagram of a computer system 900 according to one or more embodiments. The computer system 900 includes at least one processor 942 coupled to a chipset 944, as indicated in dashed lines. Also coupled to the chipset 944 are memory 946, a storage device 948, a keyboard 950, a graphics adapter 952, a pointing device 954, and a network adapter 956. A display 958 is coupled to the graphics adapter 952. In one embodiment, the functionality of the chipset 944 is provided by a memory controller hub 960 and an I/O controller hub 962. In another embodiment, the memory 946 is coupled directly to the processor 942 instead of to the chipset 944.

The storage device 948 is any non-transitory computer-readable storage medium, such as a hard drive, a compact disc read-only memory (CD-ROM), a DVD, or a solid-state memory device (e.g., a flash drive). The memory 946 holds instructions and data used by the processor 942. The pointing device 954 may be a mouse, a track pad, a track ball, or another type of pointing device, and it is used in combination with the keyboard 950 to input data into the computer system 900. The graphics adapter 952 displays images and other information on the display 958. The network adapter 956 couples the computer system 900 to a local or wide area network.

As is known in the art, the computer system 900 can have different and/or other components than those shown in FIG. 9. In addition, the computer system 900 can lack certain illustrated components. In one embodiment, the computer system 900 acting as the gateway 120 (FIG. 1) may lack the keyboard 950, pointing device 954, graphics adapter 952, and/or display 958. Moreover, the storage device 948 can be local and/or remote from the computer system 900 (such as embodied within a storage area network (SAN)). Moreover, other input devices, such as, for example, touch screens may be included.

The network adapter 956 (may also be referred to herein as a communication device) may include one or more devices for communicating using one or more of the communication media and protocols discussed above with respect to FIG. 1, FIG. 2, FIG. 3, FIG. 4A, FIG. 4B, FIG. 5A, FIG. 5B, FIG. 5C, FIG. 6A, FIG. 6B, FIG. 6C, FIG. 7, or FIG. 8.

In addition, some or all of the components of this general computer system 900 of FIG. 9 may be used as part of the processor and memory discussed above with respect to the systems or devices described for FIG. 1, FIG. 2, FIG. 3, FIG. 4A, FIG. 4B, FIG. 5A, FIG. 5B, FIG. 5C, FIG. 6A, FIG. 6B, FIG. 6C, FIG. 7, or FIG. 8.

In some embodiments, a gaming system may comprise several such computer systems 900. The gaming system may include load balancers, firewalls, and various other components for assisting the gaming system to provide services to a variety of user devices.

The computer system 900 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 948, loaded into the memory 946, and executed by the processor 942.

FIG. 3 described by way of example above, represents a data processing method (e.g., algorithm) that corresponds to at least some instructions stored and executed by a processor and/or logic circuitry associated with the gaming channel controller 120 and/or the gaming machine 10. However other embodiments can utilize processors and/or logic circuitry of any of the devices described for FIG. 1, FIG. 2, FIG. 3, FIG. 4A, FIG. 4B, FIG. 5A, FIG. 5B, FIG. 5C, FIG. 6A, FIG. 6B, FIG. 6C, FIG. 7, FIG. 8 or FIG. 9 to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
generating, by an electronic processor via one or more image capture devices, a video stream showing a first view of a land-based gaming machine physically located within a secure gaming test environment;
transmitting, by the electronic processor via a communications network, the video stream to a user computing device external to the secure gaming test environment for presentation via a screen of the user computing device;
animating, by the electronic processor in response to a user input received from the user computing device, play of an in-development wagering game presented via the first view, wherein the user input is received after transmitting the video stream;
detecting, by the electronic processor, a change in state, related to presentation of the in-development wagering game, of one or more of the gaming machine or the user computing device;
determining, by the electronic processor based on the change in state, a second view of the land-based gaming machine to present via the user computing device, wherein the second view is different from the first view; and
automatically modifying, by the electronic processor, the video stream to present the second view.

2. The method of claim 1, wherein the detecting the change in state comprises determining, by the processor via analysis of game play of the in-development wagering game, a change of a game state of the in-development wagering game.

3. The method of claim 1, wherein detecting the change in state comprises detecting, by the processor via a sensor of the user computing device, change in a physical state of the user computing device, wherein detecting the change in physical state comprises detecting, by the processor, one or more of a change of orientation, a change of direction, a change of motion, a change of position, or an acceleration of the user computing device.

4. The method of claim 1, wherein the first view shows one or more first areas of the land-based gaming machine, and wherein the second view shows one or more second areas of the land-based gaming machine different from the one or more first areas.

5. The method of claim 4, wherein automatically modifying the video stream to present the second view comprises:
determining, by the electronic processor based on a specific game event that occurs during the change in state, that the specific game event activates presentation of gaming content via the one or more second areas;
automatically modifying, by the electronic processor, a configuration of the one or more image capture devices to capture a detailed view of the one or more second areas instead of the one or more first areas;
animating, by the electronic processor after modifying the configuration of the one or more image capture devices, the video stream according to the second view; and
transmitting, by the electronic processor, the animated video stream of the second view to the user computing device for animated presentation in place of the first view.

6. The method of claim 4, wherein the automatically modifying the video stream to present the second view comprises instructing, by the electronic processor, one or more motorized elements of the one or more image capture devices to move a field of view of the one or more image capture devices from the one or more first areas to the one or more second areas.

7. The method of claim 6, wherein the one or more motorized elements are configured to change one or more of a physical position or an orientation of the one or more image capture devices.

8. The method of claim 6, wherein the one or more motorized elements comprise one or more of a zoom lens, a camera rig device, a mount, a slider, a pan head, a tilt head, a tripod, an overhead camera mount, a boom lift, a crane, a crane jib, a pole jib, a gimbal, a steadicam, a glidecam, a pedestal rig, a camera dolly, a slider rig, a camera stabilizer, a Snorricam rig, or a drone.

9. The method of claim 1, wherein the first view shows an area of a display screen of the land-based gaming machine, and wherein the automatically modifying the video stream to present the second view comprises automatically zooming, by the electronic processor via a motorized lens, on one or more subsections of the area of the display screen.

10. The method of claim 9, wherein determining the second view comprises determining, based on the change in state, that a game event occurs which shows one or more of a game outcome or a game highlight effect within the one or more subsections of the area of the display screen.

11. The method of claim 1, wherein detecting the change in state is in response to automated electronic communication, by the electronic processor, with game-logic circuitry of the land-based gaming machine.

12. The method of claim 1, wherein the first view is associated with a first game state, wherein the generating the video stream showing the first view comprises selecting, from a view configuration library based on the first game state, a first view configuration setting for the one or more image capture devices, wherein detecting the change in state comprises detecting a change from the first game state to a second game state, wherein determining the second view comprises selecting, from the view configuration library, a second view configuration setting for the one or more image capture devices based on the second game state, and wherein the automatically modifying the video stream comprises automatically applying the second view configuration setting to the one or more image capture devices.

13. The method of claim 1 further comprising:
determining, by the electronic processor, player-related feedback associated with one or more of a change in game state or the game play; and
using, by the electronic processor, the player-related feedback for modification of the in-development wagering game prior to the in-development wagering game being submitted to a jurisdictional gaming approval procedure.

14. The method of claim 13, wherein the determining the player-related feedback comprises:
animating, by the electronic processor via at least a portion of the video stream, a virtual survey that requests the player-related feedback; and
detecting, by the electronic processor via the communications network based on detection of an additional user input associated with the virtual survey, a user response containing the player-related feedback.

15. The method of claim 14 further comprising;
animating, by the electronic processor via the virtual survey, an offer of one or more virtual credits in exchange for the player-related feedback; and
incrementing, by the electronic processor in response to detecting the user response, a credit meter based on the one or more virtual credits, wherein the credit meter is associated with an online game provider server that hosts streaming of the in-development wagering game from the secure gaming test environment.

16. The method of claim 13, further comprising:
automatically modifying, by the electronic processor, a characteristic of the in-development wagering game based on the player-related feedback;
automatically updating, by the electronic processor, the second view to present the modified characteristic;
determining, by the electronic processor, additional player-related feedback associated with the modified characteristic; and
using, by the electronic processor, the additional player-related feedback for additional modification of the in-development wagering game prior to the in-development wagering game being submitted to the jurisdictional gaming approval procedure.

17. A system comprising:
a land-based gaming machine communicatively coupled to a communications network, wherein the gaming machine is physically located within a secure gaming test environment equipped with one or more image capture devices; and
a processor configured to execute instructions, which when executed cause the system to perform operations to:
generate, via electronic access to the one or more image capture devices, a video stream showing a first view of gaming machine;
transmit, via a communications network, the video stream to a user computing device external to the secure gaming test environment for presentation via a screen of the user computing device;
animate, in response to a user input received from the user computing device, play of an in-development wagering game presented via the first view, wherein the user input is received after transmission of the video stream;
detect, during play of the in-development wagering game, a change in state of one or more of the gaming machine or the user computing device, wherein the change in state is related to presentation of the in-development wagering game;
determine, based on the change in state, a second view of the land-based gaming machine to present via the user computing device, wherein the second view is different from the first view; and
automatically modify, after determination of the second view, the video stream to present the second view in place of the first view.

18. The system of claim 17, wherein the change of state initiates a community gaming feature associated with a plurality of land-based gaming machines within the secure gaming test environment, wherein the processor being configured to execute instructions to determine the second view is configured to execute instructions which, when executed, cause the system to perform operations to determine a field of view, from at least one of the one or more image capture devices, that presents the community gaming feature via the plurality of land-based gaming machines.

19. The system of claim 17, wherein the processor is further configured to execute instructions, which when executed, cause the system to perform operations to:
analyze, via one or more machine-learning models, player activity associated with the game play of the in-development wagering game;
deduce, based on analysis of the player activity via the one or more machine-learning models, player-related feedback associated with one or more of a change in game state or the game play; and
automatically modify, according to the deduced player-related feedback, an asset associated with the in-development wagering game prior to the in-development wagering game being submitted to a jurisdictional gaming approval procedure.

20. The system of claim 19, wherein analysis of the player activity comprises detection of one or more of a degree of time spent playing the in-development wagering game, a degree of progress made in attaining a goal of the in-development wagering game, a level of credits used to play the in-development wagering game, a level of winning in the in-development wagering game, a level of losing in the in-development wagering game, or attainment of one or more bonus features of the in-development wagering game.
